(19) United States
(12) Patent Application Publication
(10) Pub. No.: US 2026/0027881 A1
(43) Pub. Date: Jan. 29, 2026

(54) ELECTRIC DRIVE MODULE HAVING ANTI-BACKLASH GEAR

(71) Applicant: FCA US LLC, Auburn Hills, MI (US)

(72) Inventors: Sathya D. Kondasani, Auburn Hills, MI (US); Brian P. Heiler, Auburn Hills, MI (US); Bradley C. Jones, Auburn Hills, MI (US)

(21) Appl. No.: 18/787,203

(22) Filed: Jul. 29, 2024

(51) Int. Cl. B60K 1/00; F16H 55/18

(52) U.S. Cl. CPC B60K 1/00; F16H 55/18; B60K 2001/001; F16H 2200/0021; F16H 2200/0034

(57) ABSTRACT

An electric drive module for powering an electric vehicle includes an electric machine, a gearbox and a driveline. The electric machine has a rotor configured to rotate relative to a stator to drive a rotor shaft that provides a torque input. The gearbox has an anti-backlash gear assembly including a first gear, a second gear, and a biasing member operably disposed between the first and second gears. The anti-backlash gear assembly receives the torque input at the first gear, absorbs the torque input at the biasing member, and transfers the torque input as a torque output to the second gear. The anti-backlash gear reduces backlash at the gearbox. The driveline delivers the torque output to at least one drive wheel of the electric vehicle.

### FIELD

The present application relates generally to electric drive modules on electrified vehicles and, more particularly, to an electric drive module that incorporates an anti-backlash gear that mitigates instant torque transfer to vehicle drive wheels.

### BACKGROUND

Different types of electric vehicles, including mild hybrid electric vehicles (mHEV's), plug-in hybrid electric vehicles (PHEV's), battery electric vehicles (BEV's), and range extended battery electric vehicles (REEV's), rely on electric machines for propulsion as a main source of torque, which generates the necessary power for vehicle propulsion. These electric machines are typically provided as part of an electric drive module (EDM) that is configured to generate and transfer drive torque to a driveline including one or more drive wheels. Electric vehicles are generally heavier than conventional vehicles that are powered exclusively by an internal combustion engine due to significant added battery weight. Furthermore, electric vehicles can provide instant torque output delivered to the vehicle wheels. Due to the excess weight and instant available torque at the drive wheels, tires of electric vehicles have significantly reduced life. In this regard, while existing EDM configurations can be satisfactory, there remains a need for improvement in the relevant art.

### SUMMARY

In accordance with one example aspect of the invention, an electric drive module for powering an electric vehicle includes an electric machine, a gearbox and a driveline. The electric machine has a rotor configured to rotate relative to a stator to drive a rotor shaft that provides a torque input. The gearbox has an anti-backlash gear assembly including a first gear, a second gear, and a biasing member operably disposed between the first and second gears. The anti-backlash gear assembly receives the torque input at the first gear, absorbs the torque input at the biasing member, and transfers the torque input as a torque output to the second gear. The anti-backlash gear reduces backlash at the gearbox by virtue of the scissors gear assembly. The driveline delivers the torque output to at least one drive wheel of the electric vehicle.

In examples, the torque output is delayed from the torque input by the anti-backlash gear assembly thereby mitigating instantaneous torque transfer to the at least one drive wheel.

In examples, the torque output is dampened from the torque input by the anti-backlash gear assembly thereby mitigating immediate torque transfer to the at least one drive wheel.

In other examples, the anti-backlash gear assembly comprises a scissors gear assembly.

In other implementations, the biasing member comprises a torsion spring.

In examples, the biasing member comprises a C-shaped spring.

In other examples, the biasing member generates an elastic force that opposes a direction of rotation of the first gear.

In additional implementations, the gearbox comprises a transfer gear that incorporates the anti-backlash gear assembly.

According to an example aspect of the invention, a method for reducing backlash in an electric drive module that powers an electric vehicle is provided. The electric drive module has an electric machine including a rotor configured to rotate relative to a stator to drive a rotor shaft that provides a torque input. The method includes: providing a gearbox having an anti-backlash gear assembly including a first gear, a second gear, and a biasing member operably disposed between the first and second gears; receiving, at the first gear of the anti-backlash gear assembly, the torque input; absorbing, at the biasing member, the torque input; transferring the torque input from the biasing member to the second gear as a torque output; and providing the torque output to a driveline that delivers the torque output to at least one drive wheel of the electric vehicle.

In other examples, absorbing the torque input comprises: delaying or increasing the toque gradually with the help of the biasing member or damping the torque before it was conveyed further. The torque output can be delayed from the torque input by the anti-backlash gear assembly thereby mitigating instantaneous torque transfer to the at least one drive wheel.

In additional implementations, absorbing the torque input comprises: damping the torque output from the torque input by the anti-backlash gear assembly thereby mitigating immediate torque transfer to the at least one drive wheel.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric drive module (EDM) that incorporates an anti-backlash gear assembly, in accordance with the principles of the present application;

FIG. 2 is a schematic illustration illustrating a torque path accommodated by the anti-backlash gear assembly of FIG. 1, in accordance with the principles of the present application;

FIG. 3 is a front perspective view of an exemplary anti-backlash gear assembly in accordance with the principles of the present application;

FIG. 4 is a sectional view of the anti-backlash gear assembly taken along lines 4-4 of FIG. 3 in accordance with the principles of the present application;

FIG. 5 is a first exploded view of the anti-backlash gear assembly of FIG. 3 in accordance with the principles of the present application; and

FIG. 6 is a second exploded view of the anti-backlash gear assembly of FIG. 3 in accordance with the principles of the present application.

### DETAILED DESCRIPTION

As noted above, electric machines are typically provided as part of an electric drive module (EDM) that is configured to generate and transfer drive torque to a driveline including one or more drive wheels. Electric vehicles are generally heavier than conventional vehicles that are powered exclusively by an internal combustion engine due to significant added battery weight. Furthermore, electric vehicles can provide instant torque output delivered to the vehicle wheels. Due to the excess weight and instant available torque at the drive wheels, tires of electric vehicles have significantly reduced life.

The present disclosure provides an EDM that incorporates an anti-backlash gear assembly that mitigates instant torque transfer to vehicle drive wheels. The anti-backlash gear assembly is incorporated into the transfer or idler gear. In the examples discussed herein, the anti-backlash gear assembly includes a scissors gear, however other gear configurations may be used. The anti-backlash gear assembly includes a spring that absorbs torque such that the EDM must attain a predetermined torque before the torque is provided at the drive wheels. In this regard, instantaneous rotation of the drive wheels is delayed reducing system backlash and tire wear. Furthermore, the anti-backlash gear assembly improves the overall powertrain noise vibration and harshness (NVH) observed by the driver.

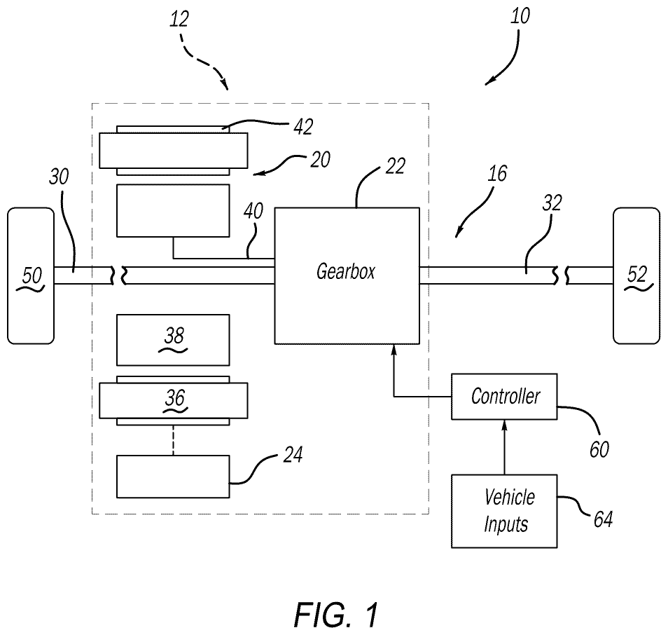

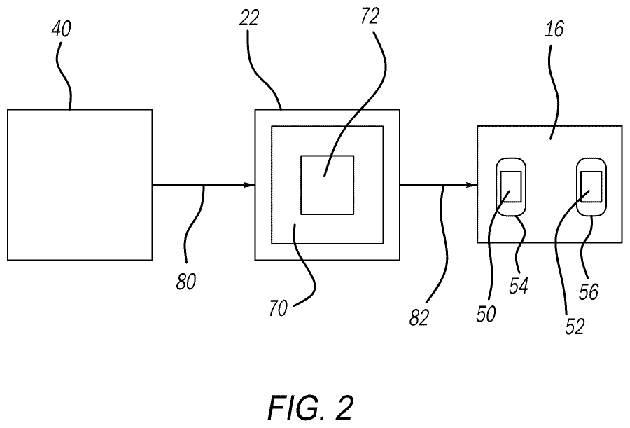

With initial reference to FIGS. 1 and 2, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), a gearbox assembly 22, and power electronics including a power inverter module (PIM) 24. The electric machine 20 is selectively connectable via the PIM 24 to a high voltage battery system (not shown) for powering the electric machine 20.

The gearbox assembly 22 is configured to transfer the generated drive torque to the driveline 16, including a first or left axle shaft 30 configured to drive a left wheel 50 and a second or right axle shaft 32 configured to drive a right wheel 52. The left wheel 50 includes a left tire 54 mounted thereon. The right wheel 52 includes a right tire 56 mounted thereon. In the example shown, the EDM 12 is configured for use on a rear axle of a two-wheel drive vehicle. It is appreciated however that the EDM 12 can be alternatively configured for use on a front axle of a two-wheel drive vehicle. In other examples an EDM 12 can be provided on both of the front and rear axles for a four-wheel drive or all-wheel drive driveline vehicle. In the example embodiment, the electric machine 20 generally includes a stator 36, a rotor assembly 38 and a rotor output shaft 40. It will be appreciated that while the exemplary vehicle 10 is configured as an electric vehicle, the electric machine 20 can be suitable for use with other vehicle configurations that have electric machines 20 including those that also employ other supplemental drive sources (e.g., hybrid vehicles that also include internal combustion engines, etc.).

With particular reference to FIG. 2, the gearbox 22 is shown having a transfer gear 70 having an anti-backlash or scissors gear assembly 72. In general, the scissor gear assembly 72 receives a torque input 80 provided by the rotor output shaft 40 and initially absorbs an amount of the torque input 80 and thereafter provides a torque output 82 to the driveline 16 (and ultimately to the wheels 50, 52 and corresponding tires 54, 56). It will be appreciated that while the gearbox 22 is shown having the transfer gear 70 incorporating the scissors gear assembly 72, additional gears can be incorporated in the gearbox 22 for providing desired torque ratios depending upon implementation. Regardless, the advantages of the scissors gear assembly 72 according to the present disclosure are realized when placed anywhere in-line between toque input 80 and torque output 82. In this regard, the instantaneous rotation of the drive wheels is delayed by the scissors gear assembly reducing system backlash and wear of the tires 54, 56.

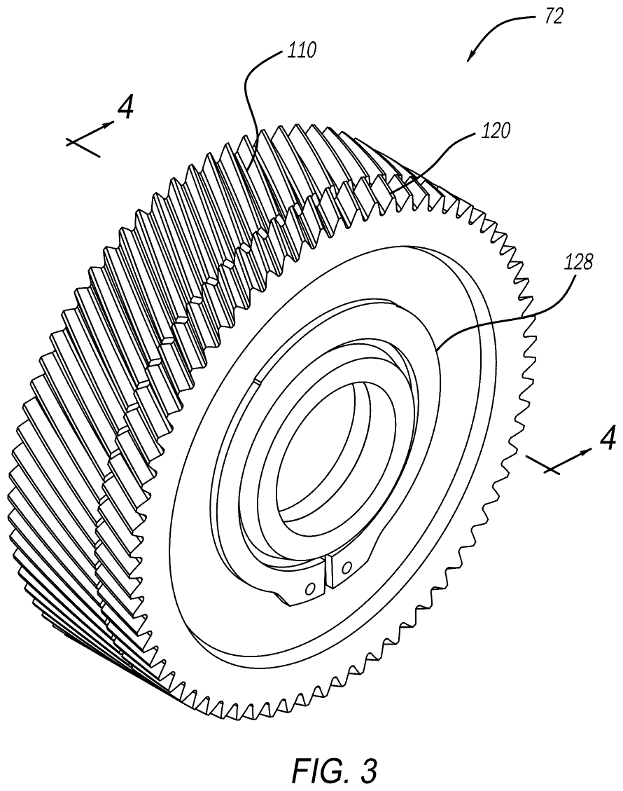

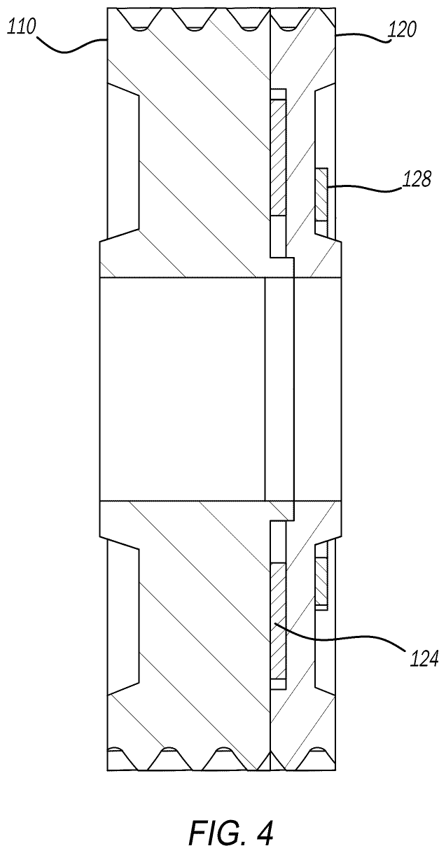

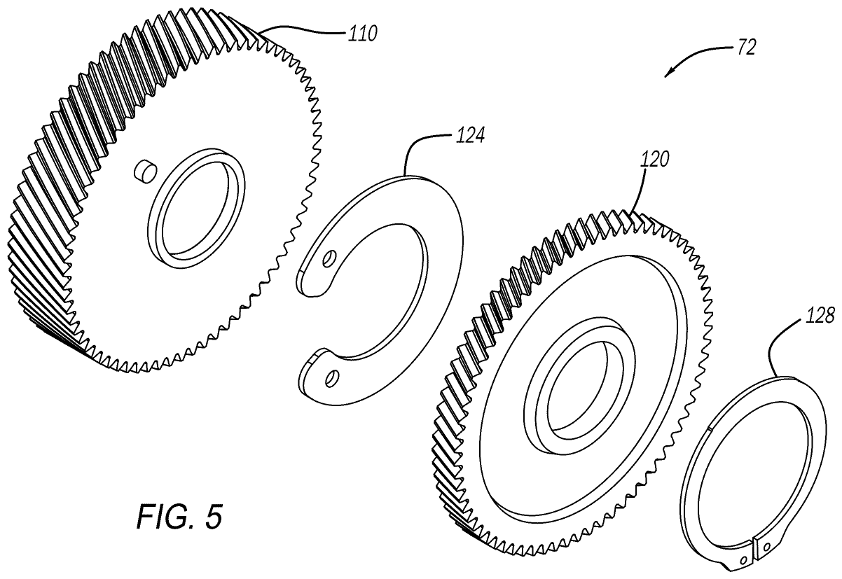

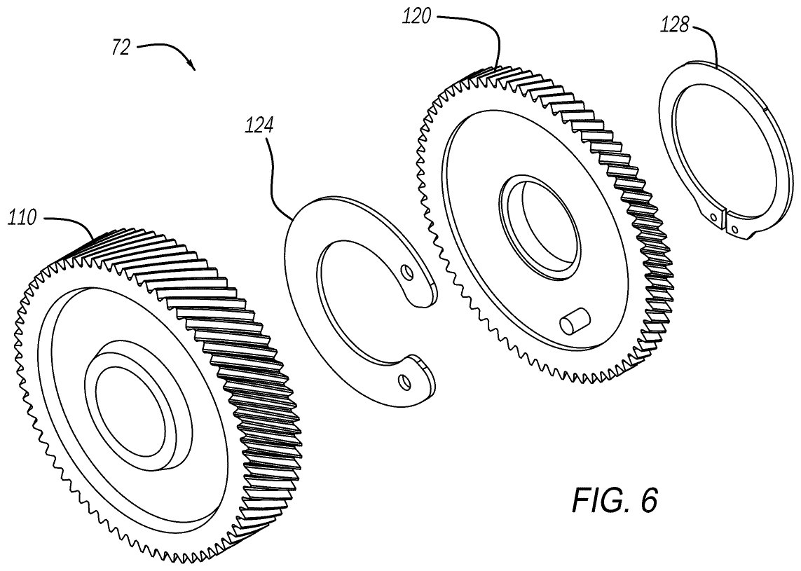

With additional reference now to FIGS. 3-6, the scissors gear assembly 72 will be further described. The scissors gear assembly 72 generally includes a first gear 110, a second gear 120, a biasing member or spring 124 and a snap ring 128. One of the first gear 110 and the second gear 120 is a fixed gear while the other of the first gear 110 and the second gear 120 is a free-rotating gear. The spring 124 is mounted between the first and second gears 110, 120 and generates an elastic force that opposes the direction of rotation. The spring 124 can be tuned based on application to absorb the required loads to provide an optimized damping function based on a particular vehicle application. The exemplary spring 124 is shown as a radial C-shaped torsion spring however it will be appreciated that the spring 124 may be configured as other springs such as, but not limited to, a leaf spring, a wave spring, or a coil spring. In additional examples a polymer can be used as a biasing medium.

The spring 124 is mounted on the first gear 110 to receive torque from the first gear 110 and initially absorb the torque while expanding before transferring the torque to the second gear 120. In the example shown, the first gear 110 can receive the torque input 80 and the second gear 120 can transmit the torque output 82. The spring 124 initially absorbs a predetermined amount of load associated with the input torque 80, building up a pre-load. The load is then transferred onto the second gear 120 and ultimately the drive wheels 50, 52 and tires 54, 56.

The anti-backlash gear assembly 72 therefore reduces direct torque transfer from the electric machine 20 to the drive wheels 50, 52 ultimately mitigating immediate torque at the drive wheels 50, 52 thereby reducing wear of the tires 54, 56. As another benefit, the anti-backlash gear assembly 72 reduces NVH observed by the driver during the torque transfer through the gearbox 22 such as during an initial acceleration event providing backlash compensation.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric drive module for powering an electric vehicle, the electric drive module comprising:
an electric machine having a rotor configured to rotate relative to a stator to drive a rotor shaft that provides a torque input;
a gearbox having an anti-backlash gear assembly including a first gear, a second gear, and a biasing member operably disposed between the first and second gears, the anti-backlash gear assembly receiving the torque input at the first gear, absorbing the torque input at the biasing member, and transferring the torque input as a torque output to the second gear, wherein the anti-backlash gear reduces backlash at the gearbox; and
a driveline that delivers the torque output to at least one drive wheel of the electric vehicle.

2. The electric drive module of claim 1, wherein the torque output is delayed from the torque input by the anti-backlash gear assembly thereby mitigating instantaneous torque transfer to the at least one drive wheel.

3. The electric drive module of claim 1, wherein the torque output is dampened from the torque input by the anti-backlash gear assembly thereby mitigating immediate torque transfer to the at least one drive wheel.

4. The electric drive module of claim 1, wherein the anti-backlash gear assembly comprises a scissors gear assembly.

5. The electric drive module of claim 4, wherein the biasing member comprises a torsion spring.

6. The electric drive module of claim 5, wherein the torsion spring comprises a C-shaped torsion spring.

7. The electric drive module of claim 1, wherein the biasing member generates an elastic force that opposes a direction of rotation of the first gear.

8. The electric drive module of claim 1, wherein the gearbox comprises a transfer gear that incorporates the anti-backlash gear assembly.

9. A method for reducing backlash in an electric drive module that powers an electric vehicle, the electric drive module having an electric machine including a rotor configured to rotate relative to a stator to drive a rotor shaft that provides a torque input, the method comprising:
providing a gearbox having an anti-backlash gear assembly including a first gear, a second gear, and a biasing member operably disposed between the first and second gears;
receiving, at the first gear of the anti-backlash gear assembly, the torque input;
absorbing, at the biasing member, the torque input;
transferring the torque input from the biasing member to the second gear as a torque output; and
providing the torque output to a driveline that delivers the torque output to at least one drive wheel of the electric vehicle.

10. The method of claim 9, wherein absorbing the torque input comprises:
delaying the torque output from the torque input by the anti-backlash gear assembly thereby mitigating instantaneous torque transfer to the at least one drive wheel.

11. The method of claim 9, wherein absorbing the torque input comprises:
damping the torque output from the torque input by the anti-backlash gear assembly thereby mitigating immediate torque transfer to the at least one drive wheel.

12. The method of claim 9, wherein the anti-backlash gear assembly comprises a scissors gear assembly.

13. The method of claim 12, wherein the biasing member comprises a torsion spring.

14. The method of claim 13, wherein the torsion spring comprises a C-shaped torsion spring.

15. The method of claim 9, wherein the biasing member generates an elastic force that opposes a direction of rotation of the first gear.

16. The method of claim 9, wherein the gearbox comprises a transfer gear that incorporates the anti-backlash gear assembly.
